(19) United States
(12) Patent Application Publication
(10) Pub. No.: US 2016/0071450 A1
(43) Pub. Date: Mar. 10, 2016

(54) PIXEL STRUCTURE, LIQUID CRYSTAL DISPLAY PANEL AND DRIVING METHOD THEREOF

(71) Applicant: Shenzhen China Star Optoelectronics Technology Co. Ltd., Shenzhen, Guangfong (CN)

(72) Inventor: Shishuai Huang, Shenzhen (CN)

(73) Assignee: Shenzhen China Star Optoelectronics Technology Co. Ltd., Shenzhen, Guangdong (CN)

(21) Appl. No.: 14/395,497

(22) PCT Filed: Sep. 16, 2014
(86) PCT No.: PCT/CN2014/086639

§ 371 Date: Oct. 20, 2014

(30) Foreign Application Priority Data
Sep. 4, 2014 (CN) 2014104487844

(51) Int. Cl. G09G 3/20; G09G 3/36

(52) U.S. Cl. CPC G09G 3/2074; G09G 3/2003; G09G 3/3696; G09G 3/3674; G09G 3/3685; G09G 3/3666; G09G 2300/0426; G09G 2310/0202; G09G 2320/0666; G09G 2320/068

(57) ABSTRACT

A pixel structure, a liquid crystal display panel and a driving method thereof are provided. The pixel structure includes multiple pixels arranged in an array. Each pixel includes adjacently disposed main and sub pixel areas. The main pixel area includes a first pixel electrode and a first control switch. The sub pixel area includes a second pixel electrode, a third pixel electrode, a second control switch and a third control switch. The first and second control switches are turned on by a first scan signal. The main and sub pixel areas are charged by a data signal to have a first potential. The third control switch is turned on by a second scan signal and thereby the third and second pixel electrodes electrically communicate with each other, so that the second and third pixel electrodes are made to have a second potential different from the first potential.

### TECHNICAL FIELD

The present invention relates to the field of display technology, and particularly to a pixel structure, a liquid crystal display panel and a driving method thereof.

### DESCRIPTION OF RELATED ART

In the conventional liquid crystal panel technology, in order to reduce the cost and be without the loss of resolution, original vertically arranged pixels are changed to be horizontally arranged, i.e., a Tri-gate architecture panel design mode has been proposed. As shown in FIG. 1, figures a) and b) both are products with an M×N resolution. Pixels in the figure a) are vertically arranged, and pixels in the figure b) are horizontally arranged. A number of gate fanout (gate pad extension line) in the figure b) after the pixels being arranged is changed from N in the figure a) to be 3N, and a number of source fanout (source pad extension line) is changed from 3M in the figure a) to be M. Compared with the traditional panel in the figure a), the number of gate fanout is changed to be 3 times while the number of source fanout is reduced to be ⅓ times. Since the gate IC is relatively simple and has a cheaper price, the whole cost of the panel using the architecture in the figure b) is lower than that of the traditional panel in the figure a).

In addition, the liquid crystal panel especially the large-sized liquid crystal panel would suffer from color shift at large viewing angle, the larger the viewing angle is, the more serious the color shift is. In order to improve the viewing angle while reduce the color shift, the large-sized panel generally is designed with low color shift by increasing the number of domain of pixel, and one pixel generally can be divided into four domains. If one pixel is divided into a main pixel area and a sub pixel area, the number of domain can be increased up to 8, the viewing angle can be improved and the color shift also can be improved. FIG. 2 is an equivalent circuit diagram of a conventional pixel with low color shift. As shown in FIG. 2, each pixel is divided into a main pixel area and a sub pixel area. When gates are turned on by a gate line, charges are supplied to the main pixel area and the sub pixel area of the pixel through a main TFT Tmain and a sub TFT Tsub respectively. E, D are abstracted into main pixel capacitances Cst main, Clc main and sub pixel capacitances Cst sub, Clc sub of a main pixel (main pixel area) and a sub pixel (sub pixel area). When the gate line is turned off while the charge share line is turned on, a sharing TFT Tcs is turned on, and some of the charges in the sub pixel is discharged to a charge sharing capacitance Cb. As a result, the sub pixel and the main pixel have a potential difference existing therebetween, and the purpose of reducing color shift is achieved.

### SUMMARY

Accordingly, a technical problem to be primarily solved by the present invention is to provide a pixel structure, a liquid crystal display panel and a driving method thereof, so as to solve the low color shift issue of a tri-gate panel without the need of additional sharing driving line and improve the aperture ratio of pixel.

In order to solve the above technical problem, a technical solution proposed by the present invention is to provide a pixel structure. The pixel structure includes a plurality of pixels arranged in an array. Each of the pixels includes adjacently disposed a main pixel area and a sub pixel area. The main pixel area includes a first pixel electrode, and the first pixel electrode is electrically connected to receive a data signal through a first control switch. The sub pixel area includes a second pixel electrode, a second pixel electrode, a second control switch and a third control switch. The second pixel electrode is electrically connected to receive the data signal through the second control switch. Control terminals of the first and second control switches are electrically connected to receive a first scan signal. The third pixel electrode is electrically connected to receive the data signal successively through the third control switch and the second control switch. A control terminal of the third control switch is electrically connected to receive a second scan signal. The third pixel electrode is electrically connected to the second pixel electrode through the third control switch. The first pixel electrode and the second pixel electrode are made to have different potentials from each other when the first control switch, the second control switch and the third control switch all are turned on.

In an exemplary embodiment, the pixel structure further includes an array substrate. The main pixel area and the sub pixel area are disposed on the array substrate. The array substrate further has transversely disposed a plurality of scan lines and longitudinally disposed a plurality of data lines thereon. The scan lines are arranged intersecting with the data lines. The main pixel area and the sub pixel area of an nth pixel of the plurality of pixels are disposed in a region defined by an nth scan line, a (n+1)th scan line, an nth data line and a (n+1)th data line.

In an exemplary embodiment, the pixel structure uses a design of eight-domain, the main pixel area is with four domains of each eight-domain, and the sub pixel area is with the other four domain of the eight-domain.

In an exemplary embodiment, the nth scan line is electrically connected to a pixel of first color, the (n+1)th scan line is electrically connected to a pixel of second color, and a (n+2)th scan line adjacent to the (n+1)th scan line is electrically connected to a pixel of third color; the first color, the second color and the third color are different colors.

In an exemplary embodiment, the pixel structure further includes a color filter substrate disposed opposite to the array substrate and a liquid crystal layer sandwiched between the array substrate and the color filter substrate. The color film substrate has a common electrode disposed thereon. The third pixel electrode and the common electrode are formed with a voltage-dividing liquid crystal capacitance therebetween by using the liquid crystal layer as dielectric. The voltage-dividing liquid crystal capacitance is for decreasing a potential of the second pixel electrode when the first control switch, the second control switch and the third control switch all are turned on, so as to make the first pixel electrode and the second pixel electrode to have the different potentials.

In an exemplary embodiment, the first control switch is a first thin film transistor, the second control switch is a second thin film transistor, and the third control switch is a third thin film transistor. The first pixel electrode is electrically connected to a drain of the first thin film transistor, a source of the first thin film transistor is electrically connected to receive the data signal, and a gate of the first thin film transistor is electrically connected to receive the first scan signal. The second pixel electrode is electrically connected to a drain of the second thin film transistor, a source of the second thin film transistor is electrically connected to receive the data signal, and a gate of the second thin film transistor is electrically connected to receive the first scan signal. The third pixel electrode is electrically connected to a drain of the third thin film transistor, a source of the third thin film transistor is electrically connected to the drain of the second thin film transistor, and a gate of the third thin film transistor is electrically connected to receive the second scan signal.

In order to solve the above technical problem, a technical solution proposed by the present invention is to provide a liquid crystal display panel. The liquid crystal display panel includes any one of the above-described pixel structures.

In order to solve the above technical problem, a technical solution proposed by the present invention is to provide a driving method of a liquid crystal display panel. The liquid crystal display panel includes a pixel structure. The pixel structure includes a plurality of pixels arranged in an array. Each pixel includes adjacently disposed a main pixel area and a sub pixel area. The main pixel area includes a first pixel electrode, and the first pixel electrode is electrically connected to receive a data signal through a first control switch. The sub pixel area includes a second pixel electrode, a third pixel electrode, a second control switch and a third control switch. The second pixel electrode is electrically connected to receive the data signal through the second control switch. Control terminals of the first and second control switches are electrically connected to receive a first scan signal. The third pixel electrode is electrically connected to receive the data signal successively through the third control switch and the second control switch. A control terminal of the third control switch is electrically connected to receive a second scan signal. The driving method of the liquid crystal display panel includes: using the first scan signal to turn on the first control switch and the second control switch; using the data signal to charge the main pixel area and the sub pixel area, so as to make the first pixel electrode and the second pixel electrode to have a same first potential; using the second scan signal to turn on the third control switch to make the third pixel electrode and the second pixel electrode to electrically communicate with each other, so as to make the second pixel electrode and the third pixel electrode to have a same second potential different from the first potential.

In an exemplary embodiment, the pixel structure further includes an array substrate. The main pixel area and the sub pixel area are disposed on the array substrate. The array substrate further includes transversely disposed a plurality of scan lines and longitudinally disposed a plurality of data lines thereon. The scan lines are arranged intersecting with the data lines. The main pixel area and the sub pixel area of an nth pixel of the plurality of pixels are disposed in a region defined by an nth scan line, a (n+1)th scan line, an nth data line and a (n+1)th data line.

In an exemplary embodiment, the nth scan line is electrically connected to a pixel of first color, the (n+1)th scan line is electrically connected to a pixel of second color, and a (n+2)th scan line is electrically connected to a pixel of third color. The first color, the second color and the third color are different colors.

Beneficial effects can be achieved by the present invention are that: compared with the prior art, each pixel includes adjacently disposed a main pixel area and a sub pixel area; the main pixel area includes a first pixel electrode, and the first pixel electrode is electrically connected to receive a data signal through a first control switch; the sub pixel area includes a second pixel electrode, a third pixel electrode, a second control switch and a third control switch; the second pixel electrode is electrically connected to receive the data signal through the second control switch, control terminals of the first and second control switches are electrically connected to receive a first scan signal, the third pixel electrode is electrically connected to receive the data signal successively through the third control switch and the second control switch, a control terminal of the third control switch is electrically connected to receive a second scan signal, the third pixel electrode is electrically connected to the second pixel electrode through the third control switch; the first pixel electrode and the second pixel electrode are made to have different potentials from each other when the first control switch, the second control switch and the third control switch all are turned on. Accordingly, the low color shift issue of Tri-gate panel can be solved, there is no need of additional charge sharing driving line, and the aperture ratio of pixel can be improved.

In order to further understand the features and technical contents of the present invention, please refer to the following detailed description and accompanying drawings of the present invention. However, the drawings are provided for the purpose of illustration and description only, and are not intended to limit the present invention.

### BRIEF DESCRIPTION OF THE DRAWINGS

Embodiments of the present invention will be described below in detail with reference to the drawings, and thereby the technical solutions of the present invention and other beneficial effects will be more apparent. In the drawings:

FIG. 1 is a schematic view of a pixel arrangement in the related art;

FIG. 2 is a schematic view of a pixel structure in the related art;

FIG. 3 is a schematic view of a pixel structure according to the present invention;

FIG. 4 is a schematic view of a pixel arrangement according to the present invention;

FIG. 5 is a schematic structural view of a single pixel according to the present invention; and

FIG. 6 is a flowchart a driving method of a liquid crystal display panel according to the present invention.

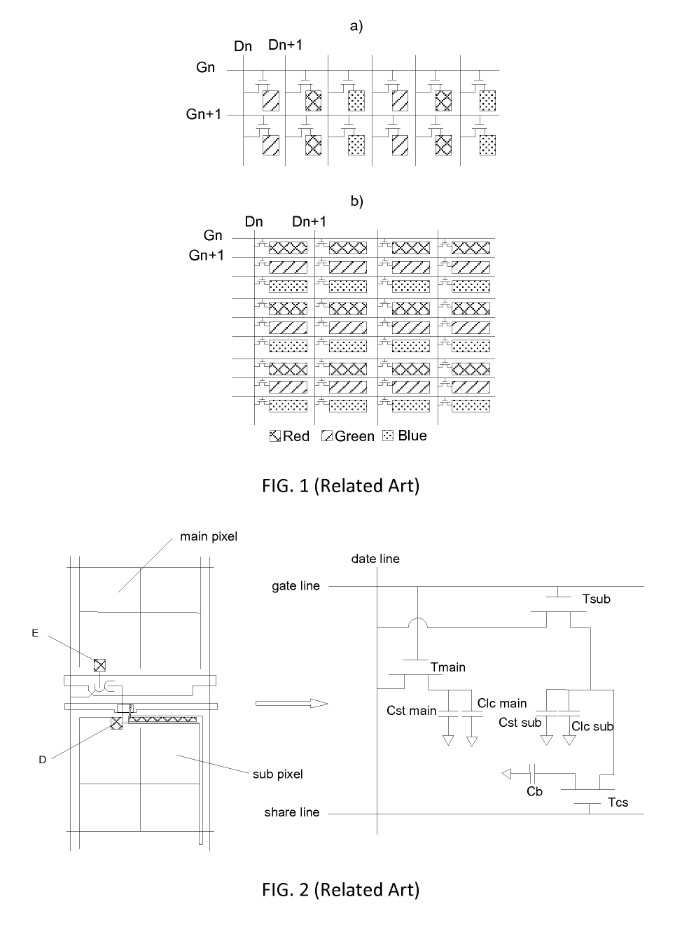

### DETAILED DESCRIPTION OF EMBODIMENTS

In the following, with reference to accompanying drawings of embodiments of the present invention, technical solutions in the embodiments of the present invention will be clearly and completely described. Apparently, the embodiments of the present invention described below only are a part of embodiments of the present invention, but not all embodiments. Based on the described embodiments of the present invention, all other embodiments obtained by ordinary skill in the art without creative effort belong to the scope of protection of the present invention.

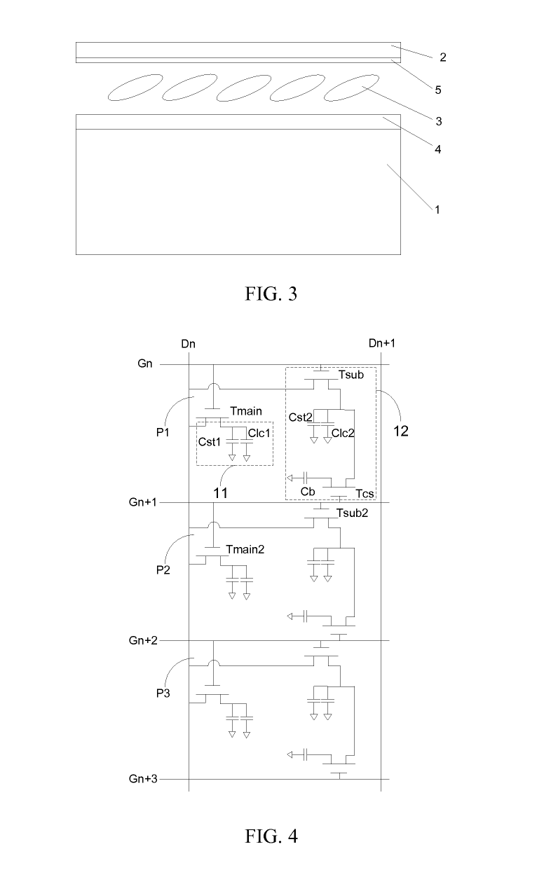

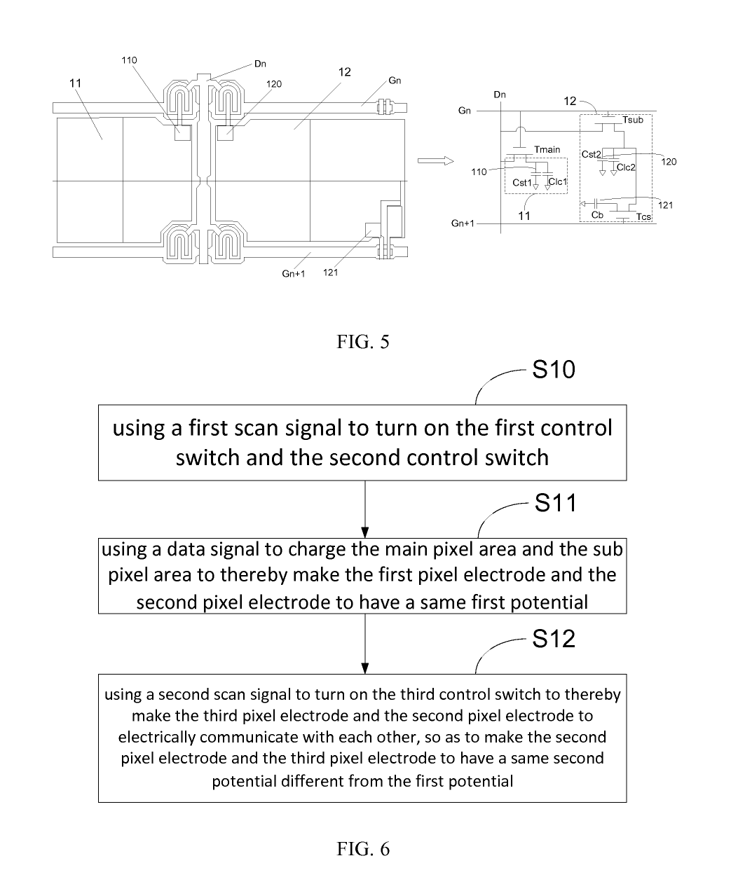

Firstly, referring to FIGS. 3 through 5, a pixel structure according to the present invention includes multiple (i.e., more than one) pixels arranged in an array. As seen from the left figure of FIG. 5, in the illustrated pixel layout structure, the pixel structure uses a design of eight-domain, a main pixel area 11 contains four domains of the eight-domain, and a sub pixel area 12 contains the other four domains of the eight-domain. Each of the pixels includes adjacently disposed the main pixel area 11 and the sub pixel area 12. The main pixel area 11 and the sub pixel area 12 respectively are arranged at two sides of a data line for delivering a data signal Dn to both the main pixel area 11 and the sub pixel area 12. The main pixel area 11 includes a first pixel electrode 110 and a first control switch Tmain. The first pixel electrode 110 is electrically connected to a liquid crystal capacitance Clc1 and a storage capacitance Cst1 and further is electrically connected to receive a data signal Dn through the first control switch Tmain. The sub pixel area 12 includes a second pixel electrode 120, a third pixel electrode 121, a second control switch Tsub and a third control switch Tcs. The second pixel electrode 120 is electrically connected to a liquid crystal capacitance Clc2 and a storage capacitance Cst2 and further is electrically connected to receive the data signal Dn through the second control switch Tsub. Control terminals of the first and second control switches Tmain, Tsub both are electrically connected to receive a first scan signal Gn. The third pixel electrode 121 is electrically connected to a voltage-dividing liquid crystal capacitance Cb and further electrically connected to receive the data signal Dn successively through the third control switch Tcs and the second control switch Tsub. A control terminal of the third control switch Tcs is electrically connected to receive a second scan signal Gn+1. The third pixel electrode 121 is electrically connected to the second pixel electrode 120 through the third control switch Tcs. When the first control switch Tmain, the second control switch Tsub and the third control switch Tcs all are turned on, the first pixel electrode 110 and the second pixel electrode 120 are made to have different potentials from each other.

In the embodiment as illustrated in FIGS. 4 and 5 of the present invention, when the second scan signal Gn+1 is turned on, the control switch Tmain2 and the control switch Tsub2 will deliver charges to the main pixel area and the sub pixel area of a succeeding pixel electrically connected to receive the second scan signal Gn+1; and at the same time the third control switch Tcs of the preceding pixel electrically connected to receive the scan signal Gn also is turned on to discharge the sub pixel area 12 and thereby the first pixel electrode 110 and the second pixel electrode 120 of the preceding pixel are made to have different potentials from each other. In this way, the third pixel electrode 121 of the nth pixel is driven by the (n+1)th scan line for delivering the scan signal Gn+1, there is no need of additional charge sharing driving line for driving the third pixel electrode 121 of the nth pixel, and thus the number of pixel driving line can be reduced, the low color shift issue of the Tri-gate panel can be solved and the aperture ratio of pixel can be improved.

The pixel structure further includes an array substrate 1, a color filter substrate 2 disposed opposite to the array substrate 1, and a liquid crystal layer 3 sandwiched between the array substrate 1 and the color filter substrate 2. A pixel electrode layer 4 is disposed on the array substrate 1. The pixel electrode layer 4 includes multiple pixels. Each of the pixels includes a main pixel area and a sub pixel area disposed on the array substrate 1. The array substrate 1 further has transversely disposed multiple scan lines and longitudinally disposed multiple data lines (not shown in FIG. 3) thereon. The scan lines are arranged intersecting with the data lines. The main pixel area 11 and the sub pixel area 12 of an nth pixel of the multiple pixels are disposed in a region defined by the nth scan line for delivering the scan signal Gn, the (n+1)th scan line for delivering the scan signal Gn+1, the nth data line for delivering the data signal Dn and the (n+1)th data line for delivering the data signal Dn+1. The nth scan line is electrically connected to a pixel P1 of first color and configured to drive the first pixel electrode and the second pixel electrode of the pixel P1 of first color. The (n+1)th scan line is electrically connected to a pixel P2 of second color and configured to drive the first pixel electrode and the second pixel electrode of the P2 of second color pixel and meanwhile to drive the third pixel electrode of the pixel P1 of first color. The (n+2)th scan line is electrically connected to a pixel P3 of third color and configured to drive the first pixel electrode and the second pixel electrode of the pixel P3 of third color and meanwhile to drive the third pixel electrode of the pixel P2 of second color. Preferably, the first color is red color, the second color is green color, and the third color is blue color. The color filter substrate 2 has a common electrode 5 disposed thereon. The third pixel electrode 121 and the common electrode 5 form a voltage-dividing liquid crystal capacitance Cb therebetween by using the liquid crystal layer as dielectric. The voltage-dividing liquid crystal capacitance Cb is configured to decrease the potential of the second pixel electrode 120 when the first control switch Tmain, the second control switch Tsub and the third control switch Tcs all are turned on and thereby the first pixel electrode 110 and the second pixel electrode 120 are made to have different potentials from each other.

In the embodiment as illustrated in FIGS. 4 and 5 of the present invention, the first control switch Tmain is a first thin film transistor, the second control switch Tsub is a second thin film transistor, and the third control switch Tcs is a third thin film transistor. The first pixel electrode 110 is electrically connected to a drain of the first thin film transistor, a source of the first thin film transistor is electrically connected to receive the data signal Dn, and a gate of the first thin film transistor is electrically connected to receive the first scan signal Gn. The second pixel electrode 120 is electrically connected to a drain of the second thin film transistor, a source of the second thin film transistor is electrically connected to receive the data signal Dn, and a gate of the second thin film transistor is electrically connected to receive the first scan line Gn. The third pixel electrode 121 is electrically connected to a drain of the third thin film transistor, a source of the third thin film transistor is electrically connected to the drain of the second thin film transistor, and a gate of the third thin film transistor is electrically connected to receive the second scan signal Gn+1.

Furthermore, an exemplary embodiment of the present invention provides a liquid crystal display panel. The liquid crystal display panel includes the above-described pixel structure, and thus will not be repeated herein.

Referring to FIG. 6, another exemplary embodiment of the present invention provides a driving method of a liquid crystal display panel. The liquid crystal display panel includes a pixel structure. The pixel structure includes multiple pixels arranged in an array. Each pixel includes adjacently disposed a main pixel area and a sub pixel area. The main pixel area includes a first pixel electrode, and the first pixel electrode is electrically connected to receive a data signal through a first control switch. The sub pixel area includes a second pixel electrode, a third pixel electrode, a second control switch and a third control switch. The second pixel electrode is electrically connected to receive the data signal through the second control switch. Control terminals of the first control switch and the second control switch both are electrically connected to receive a first scan signal. The third pixel electrode is electrically connected to receive the data signal successively through the third control switch and the second control switch. A control terminal of the third control switch is electrically connected to receive a second scan signal. The driving method of the liquid crystal display panel includes the following steps:

S10: using the first scan signal to turn on the first control switch and the second control switch;

S11: using the data signal to charge the main pixel area and the sub pixel area to thereby make the first pixel electrode and the second pixel electrode to have a same first potential;

S12: using the second scan signal to turn on the third control switch to thereby make the third pixel electrode and the second pixel electrode to electrically communicate with each other, so as to make the second pixel electrode and the third pixel electrode to have a same second potential different from the first potential.

In the step S12, when the second scan signal controls the third control switch to be turned on and thereby the second pixel electrode and the third pixel electrode are made to have the same second potential different from the first potential, the second scan signal further controls the first control switch and the second control switch of a succeeding pixel to be turned on so as to deliver charges the main pixel area and the sub pixel area of the succeeding pixel. That is, the second scan signal for the preceding pixel is the first scan signal for the succeeding pixel. In this way, the third pixel electrode of the preceding pixel uses the scan signal for driving the first pixel electrode and the second pixel electrode of the succeeding pixel and thus there is no need of additional charge sharing driving line for driving the third pixel electrode. Accordingly, the number of pixel driving line can be reduced, the low color shift issue of Tri-gate panel can be solved, and the aperture ratio of pixel can be improved.

In the embodiment of the present invention, the pixel structure further includes an array substrate. The main pixel area and the sub pixel area are disposed on the array substrate. The array substrate further has transversely disposed multiple scan lines and longitudinally disposed multiple data lines thereon. The scan lines are arranged intersecting with the data lines. The main pixel area and the sub pixel area of an nth pixel of the multiple pixels both are disposed in a region defined by the nth scan line, the (n+1)th scan line, the nth data line and the (n+1)th data line. The nth scan line is electrically connected to a pixel of first color and configured to drive the first pixel electrode and the second pixel electrode of the pixel of first color. The (n+1)th scan line is electrically connected to a pixel of second color and configured to drive the first pixel electrode and the second pixel electrode of the pixel of second color and meanwhile to drive the third pixel electrode of the pixel of first color. The (n+2)th scan line is electrically connected to a pixel of third color and configured to drive the first pixel electrode and the second pixel electrode of the pixel of third color and meanwhile to drive the third pixel electrode of the pixel of second color. The first color, the second color and the third color are different colors. Preferably, the first color is red color, the second color is green color, and the third color is blue color.

In summary, the pixel structure of the present invention includes multiple pixels arranged in an array. Each pixel includes adjacently disposed a main pixel area and a sub pixel area. The main pixel area includes a first pixel electrode, and the first pixel electrode is electrically connected to receive a data signal through a first control switch. The sub pixel area includes a second pixel electrode, a third pixel electrode, a second control switch and a third control switch. The second pixel electrode is electrically connected to receive the data signal through the second control switch. Control terminals of the first and second control switches both are electrically connected to receive a first scan signal. The third pixel electrode is electrically connected to receive the data signal successively through the third control switch and the second control switch. A control terminal of the third control switch is electrically connected to receive a second scan signal. The third pixel electrically is electrically connected to the second pixel electrode through the third control switch. When the first control switch, the second control switch and the third control switch all are turned on, the first pixel electrode and the second pixel electrode are made to have different potentials from each other. As a result, the low color shift issue of Tri-gate panel can be solved, there is no need of additional charge sharing driving line, and the aperture ratio of pixel can be improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pixel structure comprising a plurality of pixels arranged in an array, each of the plurality of pixels comprising adjacently disposed a main pixel area and a sub pixel area; wherein:
the main pixel area comprises a first pixel electrode, and the first pixel electrode is electrically connected to receive a data signal through a first control switch;
the sub pixel area comprises a second pixel electrode, a third pixel electrode, a second control switch and a third control switch, the second pixel electrode is electrically connected to receive the data signal through the second control switch, control terminals of the first and second control switches are electrically connected to receive a first scan signal, the third pixel electrode is electrically connected to receive the data signal successively through the third control switch and the second control switch, a control terminal of the third control switch is electrically connected to receive a second scan signal, the third pixel electrode further is electrically connected to the second pixel electrode through the third control switch, and the first pixel electrode and the second pixel electrode are made to have different potentials from each other when the first control switch, the second control switch and the third control switch all are turned on.

2. The pixel structure as claimed in claim 1, wherein the pixel structure further comprises an array substrate, the main pixel area and the sub pixel area are disposed on the array substrate; the array substrate further comprises transversely disposed a plurality of scan lines and longitudinally disposed a plurality of data lines, the plurality of scan lines are arranged intersecting with the plurality of the data lines;
the main pixel area and the sub pixel area of an nth pixel of the plurality of pixels are disposed in a region defined by an nth scan line, a (n+1)th scan line, an nth data line and a (n+1)th data line; and the sub pixel area is electrically connected to both the nth scan line and the (n+1)th scan line.

3. The pixel structure as claimed in claim 2, wherein the pixel structure uses a design of eight-domain, the main pixel area is with four domains of each eight-domain, and the sub pixel area is with the other four domains of the eight-domain.

4. The pixel structure as claimed in claim 2, wherein the nth scan line is electrically connected to a pixel of first color, the (n+1)th scan line is electrically connected to a pixel of second color, and a (n+2)th scan line adjacent to the (n+1) the scan line is electrically connected to a pixel of third color; the first color, the second color and the third color are different colors.

5. The pixel structure as claimed in claim 2, wherein the pixel structure further comprises a color filter substrate disposed opposite to the array substrate and a liquid crystal layer sandwiched between the array substrate and the color filter substrate; the color filter substrate has a common electrode disposed thereon, the third pixel electrode and the common electrode are formed with a voltage-dividing liquid crystal capacitance therebetween by using the liquid crystal layer as dielectric; the voltage-dividing liquid crystal capacitance is for decreasing a potential of the second pixel electrode when the first, second and third control switches all are turned on, so as to make the first pixel electrode and the second pixel electrode to have the different potentials.

6. The pixel structure as claimed in claim 1, wherein the first control switch is a first thin film transistor, the second control switch is a second thin film transistor, and the third control switch is a third thin film transistor; the first pixel electrode is electrically connected to a drain of the first thin film transistor, a source of the first thin film transistor is electrically connected to receive the data signal, and a gate of the first thin film transistor is electrically connected to receive the first scan signal; the second pixel electrode is electrically connected to a drain of the second thin film transistor, a source of the second thin film transistor is electrically connected to receive the data signal, and a gate of the second thin film transistor is electrically connected to receive the first scan signal; the third pixel electrode is electrically connected to a drain of the third thin film transistor, a source of the third thin film transistor is electrically connected to the drain of the second thin film transistor, and a gate of the third thin film transistor is electrically connected to receive the second scan signal.

7. A liquid crystal display panel comprising a pixel structure;
wherein the pixel structure comprises a plurality of pixels arranged in an array, each of the plurality of pixels comprises adjacently disposed a main pixel area and a sub pixel area;
the main pixel area comprises a first pixel electrode, and the first pixel electrode is electrically connected to receive a data signal through a first control switch;
the sub pixel area comprises a second pixel electrode, a third pixel electrode, a second control switch and a third control switch, the second pixel electrode is electrically connected to receive the data signal through the second control switch, control terminals of the first and second control switches are electrically connected to receive a first scan signal, the third pixel electrode is electrically connected to receive the data signal successively through the third control switch and the second control switch, a control terminal of the third control switch is electrically connected to receive a second scan signal, the third pixel electrode further is electrically connected to the second pixel electrode through the third control switch, and the first electrode and the second pixel electrode are made to have different potentials from each other when the first control switch, the second control switch and the third control switch all are turned on.

8. The liquid crystal display panel as claimed in claim 7, wherein the pixel structure further comprises an array substrate, the main pixel area and the sub pixel area are disposed on the array substrate; the array substrate further comprises transversely disposed a plurality of scan lines and longitudinally disposed a plurality of data lines, the plurality of scan lines are arranged intersecting with the plurality of the data lines;
the main pixel area and the sub pixel area of an nth pixel of the plurality of pixels are disposed in a region defined by an nth scan line, a (n+1)th scan line, an nth data line and a (n+1)th data line; and the sub pixel area is electrically connected to both the nth scan line and the (n+1)th scan line.

9. The liquid crystal display panel as claimed in claim 8, wherein the pixel structure uses a design of eight-domain, the main pixel area is with four domains of each eight-domain, and the sub pixel area is with the other four domains of the eight-domain.

10. The liquid crystal display panel as claimed in claim 8, wherein the nth scan line is electrically connected to a pixel of first color, the (n+1)th scan line is electrically connected to a pixel of second color, and a (n+2)th scan line adjacent to the (n+1)th scan line is electrically connected to a pixel of third color; the first color, the second color and the third color are different colors.

11. The liquid crystal display panel as claimed in claim 8, wherein the pixel structure further comprises a color filter substrate disposed opposite to the array substrate and a liquid crystal layer sandwiched between the array substrate and the color filter substrate; the color filter substrate has a common electrode disposed thereon, the third pixel electrode and the common electrode are formed with a voltage-dividing liquid crystal capacitance therebetween by using the liquid crystal layer as dielectric; the voltage-dividing liquid crystal capacitance is for decreasing a potential of the second pixel electrode when the first, second and third control switches all are turned on, so as to make the first pixel electrode and the second pixel electrode to have the different potentials.

12. The liquid crystal display panel as claimed in claim 7, wherein the first control switch is a first thin film transistor, the second control switch is a second thin film transistor, and the third control switch is a third thin film transistor; the first pixel electrode is electrically connected to a drain of the first thin film transistor, a source of the first thin film transistor is electrically connected to receive the data signal, and a gate of the first thin film transistor is electrically connected to receive the first scan signal; the second pixel electrode is electrically connected to a drain of the second thin film transistor, a source of the second thin film transistor is electrically connected to receive the data signal, and a gate of the second thin film transistor is electrically connected to receive the first scan signal; the third pixel electrode is electrically connected to a drain of the third thin film transistor, a source of the third thin film transistor is electrically connected to the drain of the second thin film transistor, and a gate of the third thin film transistor is electrically connected to receive the second scan signal.

13. A driving method of a liquid crystal display panel, wherein the liquid crystal display panel comprises a pixel structure, the pixel structure comprises a plurality of pixels arranged in an array, each of the plurality of pixels comprises adjacently disposed a main pixel area and a sub pixel area; the main pixel area comprises a first pixel electrode, and the first pixel electrode is electrically connected to receive a data signal through a first control switch; the sub pixel area comprises a second pixel electrode, a third pixel electrode, a second control switch and a third control switch; the second pixel electrode is electrically connected to receive the data signal through the second control switch, control terminals of the first and second control switches are electrically connected to receive a first scan signal, the third pixel electrode is electrically connected to receive the data signal successively through the third control switch and the second control switch, a control terminal of the third control switch is electrically connected to receive a second scan signal; the driving method of the liquid crystal display panel comprising:
using the first scan signal to turn on the first control switch and the second control switch;
using the data signal to charge the main pixel area and the sub pixel area, so as to make the first pixel electrode and the second pixel electrode to have a same first potential;
using the second scan signal to turn on the third control switch to make the third pixel electrode and the second pixel electrode to electrically communicate with each other, so as to make the second pixel electrode and the second pixel electrode to have a same second potential different from the first potential.

14. The driving method as claimed in claim 13, wherein the pixel structure further comprises an array substrate, the main pixel area and the sub pixel area are disposed on the array substrate; the array substrate further comprises transversely disposed a plurality of scan lines and longitudinally disposed a plurality of data lines, the plurality of scan lines are arranged intersecting with the plurality of the data lines;
the main pixel area and the sub pixel area of an nth pixel of the plurality of pixels are disposed in a region defined by an nth scan line, a (n+1)th scan line, an nth data line and a (n+1)th data line; and the sub pixel area is electrically connected to both the nth scan line and the (n+1)th scan line.

15. The driving method as claimed in claim 14, wherein the nth scan line is electrically connected to a pixel of first color, the (n+1)th scan line is electrically connected to a pixel of second color, and a (n+2)th scan line adjacent to the (n+1)th scan line is electrically connected to a pixel of third color; the first color, the second color and the third color are different color.
